(19) United States
(12) Patent Application Publication
(10) Pub. No.: US 2013/0241134 A1
(43) Pub. Date: Sep. 19, 2013

(54) SHEET FEEDING DEVICE CAPABLE OF SKEW CORRECTION AND IMAGE FORMING APPARATUS INCLUDING THE SAME

(71) Applicants: Teruo NAGASHIMA, Toyohashi-shi (JP); Masao ICHIYANAGI, Toyokawa-shi (JP); Yasuo NAKAMURA, Toyokawa-shi (JP); Masashi KAWAI, Toyohashi-shi (JP); Atsushi ARAI, Tachikawa-shi (JP); Yasuo SHIOKAWA, Toyokawa-shi (JP)

(72) Inventors: Teruo NAGASHIMA, Toyohashi-shi (JP); Masao ICHIYANAGI, Toyokawa-shi (JP); Yasuo NAKAMURA, Toyokawa-shi (JP); Masashi KAWAI, Toyohashi-shi (JP); Atsushi ARAI, Tachikawa-shi (JP); Yasuo SHIOKAWA, Toyokawa-shi (JP)

(21) Appl. No.: 13/796,272

(22) Filed: Mar. 12, 2013

(30) Foreign Application Priority Data
Mar. 14, 2012 (JP) 2012-057584

(51) Int. Cl. B41J 13/26

(52) U.S. Cl. CPC B41J 13/26
USPC 271/10.11

(57) ABSTRACT

An image forming apparatus includes a sheet feeding device that corrects skew of a sheet before feeding the sheet to a transfer position for image formation. The sheet feeding device comprises a driver, a feeder roller unit provided with a feeder roller rotationally driven by the driver and a separation roller, and two resist roller units each provided with a primary and a secondary resist roller. The resist roller units cause formation of a loop in the sheet between the resist roller units and the feeder roller unit during skew correction. When viewed in a direction of a rotational axis of the feeder roller, the first resist rollers and the feeder roller overlap at least partially, and the pressing member and the second resist rollers do not overlap. The first resist rollers and the feeder roller occupy different positions with respect to the direction of the rotational axis.

This application is based on an application No. 2012-57584 filed in Japan, the contents of which are hereby incorporated by reference.

### BACKGROUND OF THE INVENTION

(1) Field of the Invention

The present invention relates a sheet feeding device and an image forming apparatus provided with the sheet feeding device.

(2) Description of the Related Art

In general, an image forming apparatus, such as a photocopier, printer, fax machine, or MFP (Multi Function Peripheral), has a configuration where a toner image formed on an image carrier, such as a photoconductive drum or an intermediate transfer belt, is transferred onto a recording sheet conveyed from a sheet feeder along a conveyance path. After transfer of the toner image onto the recording sheet, the toner image is fixed by a fixing unit.

Generally, in the above type of image forming apparatus, recording sheets are stacked in a feeder tray and an uppermost recording sheet among the stacked recording sheets is conveyed from the feeder tray by a pick-up roller and along a conveyance path by a feeder roller pair. Subsequently, skew correction of the recording sheet is performed by a resist roller pair positioned upstream of a transfer position. There above type of configuration is recited in Japanese Patent Publication No. 2002-244526.

In the type of configuration above, skew correction is performed by formation of a loop in the recording sheet. A leading part of the recording sheet being conveyed by the feeder roller pair, is impacted against a nip of the resist roller pair which are in a state of non-rotation, thus causing formation of the loop. When the loop is formed, stiffness of the recording sheet causes an edge of the leading part of the recording sheet to be pressed against the nip so as to become parallel to an axis of the resist roller pair. Once in the state described above, rotation of the resist roller pair causes the recording sheet to pass through the nip in a skew corrected state.

In recent years, in order to allow production of more compact image forming apparatuses, there has been a demand to reduce separation between configuration elements. Consequently, separation between the feeder tray and the resist roller pair should preferably be as small as possible.

Unfortunately, during skew correction by the resist roller pair, sufficient separation between the feeder tray and the resist roller pair is required in order that the loop can be formed in the recording sheet. Therefore, there is a problem that if separation between the feeder tray and the resist roller pair is reduced, the separation may be insufficient for the loop to be formed, and thus skew correction may be complicated.

### SUMMARY OF THE INVENTION

### Problems to be Solved by the Invention

In response to the above problem, the present invention aims to provide a sheet feeding device and an image forming apparatus including the sheet feeding device, wherein spatial efficiency is improved while also ensuring reliable loop formation in sheets during skew correction.

### Means for Solving the Problems

In order to achieve the above aim, one aspect of the present invention is an image forming apparatus for forming an image, including a sheet feeding device that corrects skew of a sheet before feeding the sheet to a transfer position of a toner image for image formation, the sheet feeding device comprising: a driver; a feeder roller unit provided with a feeder roller that is rotationally driven by the driver, and a pressing member that presses against a circumferential surface of the feeder roller forming a first nip; and at least two resist roller units that cause formation of a loop in the sheet between the resist roller units and the feeder roller unit during skew correction, each resist roller unit provided with a first resist roller and a second resist roller that press against one another forming a second nip, wherein the first resist roller and the feeder roller are positioned so that (i) when viewed in a direction of a rotational axis of the feeder roller, the first resist roller and the feeder roller overlap at least partially, and (ii) the first resist roller and the feeder roller occupy different positions with respect to the direction of the rotational axis, and the pressing member and the second resist roller are positioned so that when viewed in the direction of the rotational axis, the pressing member and the second resist roller do not overlap.

In order to achieve the above aim, another aspect of the present invention is a sheet feeding device for feeding a sheet and correcting skew thereof, the sheet feeding device comprising: a driver; a feeder roller unit provided with a feeder roller that is rotationally driven by the driver, and a pressing member that presses against a circumferential surface of the feeder roller forming a first nip; and at least two resist roller units that cause formation of a loop in the sheet between the resist roller units and the feeder roller unit during skew correction, each resist roller unit provided with a first resist roller and a second resist roller that press against one another forming a second nip, wherein the first resist roller and the feeder roller are positioned so that (i) when viewed in a direction of a rotational axis of the feeder roller, the first resist roller and the feeder roller overlap at least partially, and (ii) the first resist roller and the feeder roller occupy different positions with respect to the direction of the rotational axis, and the pressing member and the second resist roller are positioned so that when viewed in the direction of the rotational axis, the pressing member and the second resist roller do not overlap.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a schematic diagram showing configuration of a printer including a sheet feeding device relating to a first embodiment of the present invention;

FIG. 2 is a partially cutaway perspective view showing configuration of the sheet feeding device included in the printer;

FIG. 3 is a partially cutaway perspective view showing configuration of a reverse drive charging unit included in the sheet feeding device;

FIG. 4A, FIG. 4B and FIG. 4C show the sheet feeding device during operation;

FIG. 5 is a partially cutaway perspective view for explaining configuration of a sheet feeding device relating to a second embodiment;

FIG. 6A, FIG. 6B and FIG. 6C show the sheet feeding device relating to the second embodiment during operation;

FIG. 7 is a partially cutaway perspective view showing configuration of a sheet feeding device relating to a third embodiment;

FIG. 8 is a lateral view of the sheet feeding device relating to the third embodiment;

FIG. 9 is a broken down perspective view showing main elements of a sheet feeding device relating to a first modified example; and

FIG. 10 is a broken down perspective view showing main elements of a sheet feeding device relating to a second modified example.

### DESCRIPTION OF THE PREFERRED EMBODIMENTS

### First Embodiment

The following describes, with reference to the drawings, an image forming apparatus including a sheet feeding device relating to a first embodiment of the present invention.

### Image Forming Apparatus Configuration

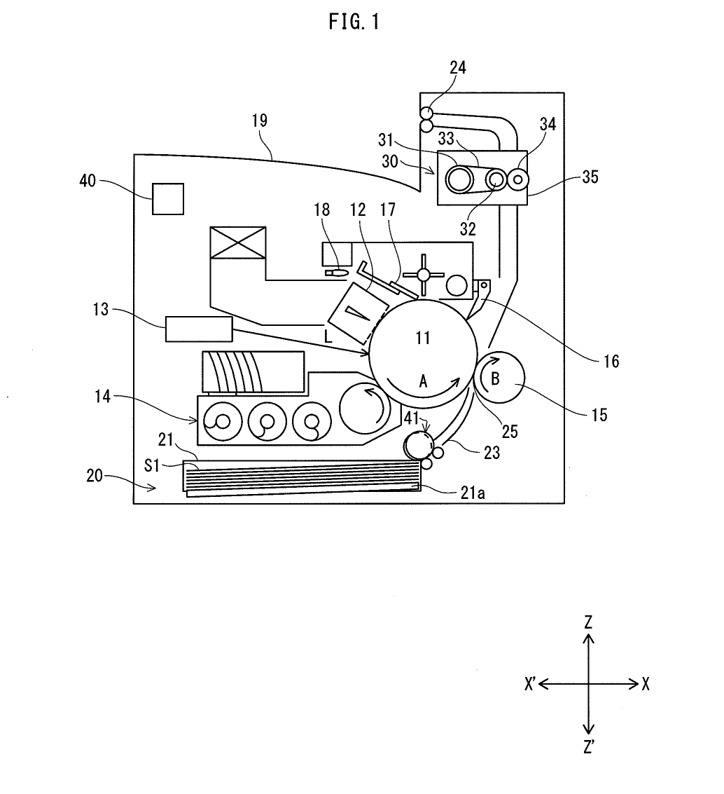

FIG. 1 is a schematic diagram for explaining configuration of a printer which is one example of the image forming apparatus including the sheet feeding device relating to the first embodiment of the present invention. The printer is for forming a monochrome toner image on a recording sheet, such as a paper sheet or an OHP sheet.

The image forming apparatus shown in FIG. 1 includes a photoconductive drum 11 that is driven in a rotational direction shown by an arrow A. The photoconductive drum 11 is held horizontally level between a front side and a rear side of the image forming apparatus (between a near side and a far side of FIG. 1).

In order to form the toner image on the recording sheet through an electrophotographic method, a charger 12, an optical unit 13, a developer 14 and a transfer roller 15 are provided around the photoconductive drum 11 in respective order in the rotational direction of the photoconductive drum 11 (anti-clockwise direction in FIG. 1).

In the printer, a control unit 40 converts image data input from an external device into a drive signal for a laser diode, and a laser diode provided in the optical unit 13 is driven by the drive signal.

As a result of the above, a surface of the photoconductive drum 11 is irradiated by laser light L from the optical unit 13, in accordance with the image data.

The surface of the photoconductive drum 11 is charged in advance to a determined electrical potential by the charger 12 so that, when exposed to the laser light L from the optical unit 13, an electrostatic latent image is formed on the surface. The electrostatic latent image is developed by the developer 14 using a toner, thus forming a toner image.

A sheet feeder 20 is positioned below the photoconductive drum 11. The sheet feeder 20 includes a feeder tray 21, on which a plurality of recording sheets such as paper or OHP sheets are stacked, and a feeder mechanism 41 (the sheet feeding device).

In the first embodiment, the feeder mechanism 41 picks-up a single uppermost recording sheet among the plurality of recording sheets stacked in the feeder tray 21 (below the uppermost recording sheet is referred to as recording sheet S1). The feeder mechanism 41 performs skew correction on the recording sheet S1 and conveys the recording sheet S1 to a conveyance path 23 that leads towards the photoconductive drum 11.

The feeder tray 21 has a sheet stacking surface 21 a, which is raised and lowered by a driver (omitted in FIG. 1).

A transfer roller 15, which rotates in a direction shown by arrow B, is positioned horizontally adjacent to and in pressure contact with the photoconductive drum 11. The pressure contact between the transfer roller 15 and the photoconductive drum 11 forms a transfer nip 25. The recording sheet S1, after being conveyed along the conveyance path 23, is conveyed into the transfer nip 25.

Thus, the recording sheet S1 supplied from the sheet feeder 20 to the conveyance path 23, is conveyed directly to the transfer nip 25 by the sheet feeder 20.

The recording sheet S1 enters the transfer nip 25, and while passing therethrough the toner image on the photoconductive drum 11 is transferred onto the recording sheet S1, due to a transfer electric field created by a transfer voltage applied against the transfer roller 15.

The recording sheet S1, with the toner image formed thereon, is separated from the photoconductive drum 11 by a separation claw 16, and conveyed to a fixing unit 30.

After the toner image has been transferred to the recording sheet S1, the photoconductive drum 11 is cleaned by a cleaning unit 17.

The fixing unit 30 includes a heating roller 31 and a fixing roller 32, that are arranged horizontally level with one another, and a fixing belt 33 which is wound and cyclically driven around the heating roller 31 and the fixing roller 32. The fixing unit 30 also includes a pressing roller 34 which is in an opposing position to the fixing roller 32 and horizontally level therewith. The fixing roller 32 and the pressing roller 34 sandwich the fixing belt 33 therebetween.

A heating lamp (halogen lamp) is provided within the heating roller 31, and the fixing belt 33 wound around the heating roller 31 is heated by the heating lamp. At a position where the fixing belt 33 and the pressing roller 34 are in pressure contact a fixing nip is formed, through which the recording sheet S1 with the toner image formed thereon passes.

As the recording sheet S1 passes through the fixing nip, the toner image on the recording sheet S1 is heated to a predetermined fixing temperature by the fixing belt 33, and thus the toner image is fixed on the recording sheet S1.

After passing through the fixing nip, the recording sheet S1 is conveyed to ejection rollers 24 by the fixing belt 33 and the pressing roller 34. The recording sheet S1 is subsequently ejected onto an ejection tray 19 by the ejection rollers 24.

### Feeder Mechanism Configuration

The feeder mechanism 41 is positioned at a feeding inlet of the feeder tray 21, and is configured to pick-up the uppermost recording sheet S1 stacked in the feeder tray 21 (refer to FIG. 1), perform skew correction on the recording sheet S1, and convey the recording sheet S1 to the conveyance path 23.

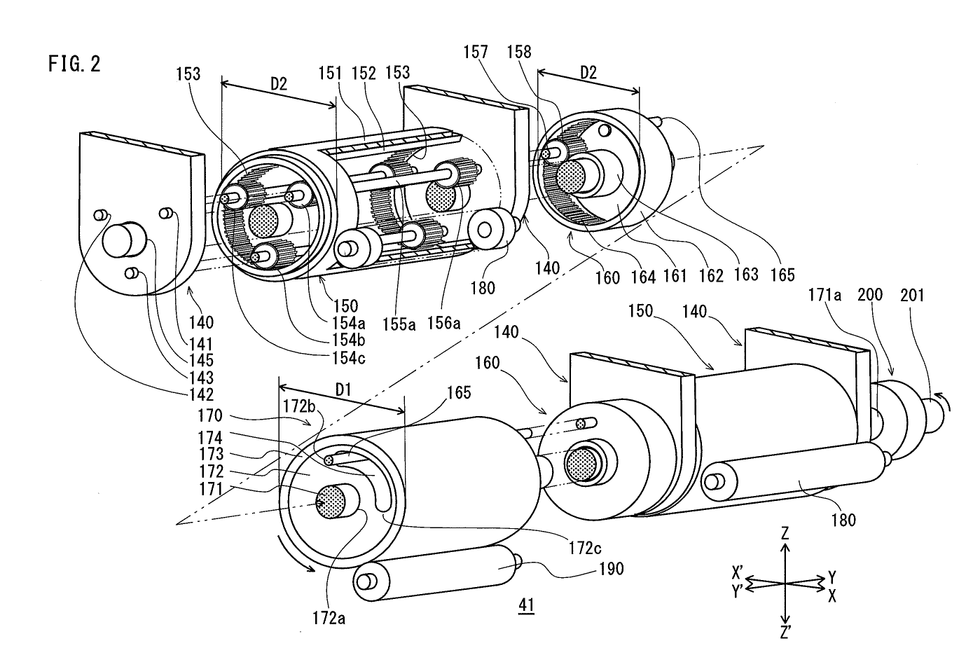

FIG. 2 is a partially cutaway perspective diagram for explaining configuration of main elements of the feeder mechanism 41. For convenience of drawing, parts further left than feeder roller 170 are shown in a partially cutaway form at the top left of FIG. 2.

As shown in FIG. 2, the feeder mechanism 41 includes supporting members 140, primary resist rollers 150, coupling units 160, a feeder roller 170, secondary resist rollers 180, a separation roller 190, and a reverse drive charging unit 200. The feeder roller 170 is fixed approximately centrally on a primary roller axle 171. The primary resist rollers 150 are positioned one each at opposite ends of the feeder roller 170 along the primary roller axle 171, and each of the primary resist rollers 150 is held freely rotatably by a pair of the supporting members 140. The four supporting members 140 are each provided with a through hole 145, into which the primary roller axle 171 is moveably inserted.

The feeder roller 170 is in contact with the uppermost recording sheet S1 stacked in the feeder tray 21, and functions as a pick-up roller by picking-up recording sheets one by one. The feeder roller 170 is formed from the primary roller axle 171, a core part 172 and a peripheral part 173.

The primary roller axle 171 is a shaft formed from a rigid metal or the like, and is fixed to the feeder roller 170 either through forceful insertion into an axle hole 172a in the core part 172, or through use of an adhesive.

The core part 172 is provided with a long arc-shaped hole 174, which is concentric to the feeder roller 170, and runs through the core part 172 in an axial direction between opposite ends of the feeder roller 170. The long arc-shaped hole 174 serves a function in causing rotational movement of the primary resist rollers 150 coupled to rotational movement of the feeder roller 170.

The peripheral part 173 is formed from an elastic material, such as rubber, of uniform thickness, which covers an outer circumferential surface of the core part 172.

The separation roller 190 is in pressure contact with an outer circumferential surface of the feeder roller 170, and has a function of separating recording sheets picked-up by the feeder roller 170 into single sheets.

A torque limiter (omitted in FIG. 2) is attached to an axle of the separation roller 190, and is configured so that a predetermined torque arises when the axle is rotationally driven.

The above configuration ensures that when a plurality of recording sheets become sandwiched between the feeder roller 170 and the separation roller 190, only the uppermost recording sheet S1 is picked-up.

Each of the primary resist rollers 150 includes a wheel part 152, which is a hollow cylinder. An outer skin 151 of uniform thickness is formed on a circumferential surface of the wheel part 152 by an elastic material such as rubber. At each end of the wheel part 152 in terms of an axial direction, an inner circumference gear 153 is formed on an inner circumferential surface of the wheel part 152. A diameter D2 of the outer skin 152 is equal to a diameter D1 of the feeder roller 170.

Axle holes 141, 142, and 143 are provided in each of the pairs of supporting members 140 holding the primary resist rollers 150. The axle holes 141, 142, and 143 respectively hold and allow free rotation of internal gears 154a, 154b and 154c, each being identical in shape and teeth number.

The internal gears 154a, 154b and 154c mesh with the inner circumference gears 153 of the primary resist roller 150, therefore ensuring the primary resist roller 150 is held by the pair of supporting members 140, but is able to rotate freely in relation to the pair of supporting members 140.

Positioning of the axle holes 141, 142, and 143 in each of the supporting members 140 is determined so that a center of rotation of the primary resist rollers 150 (resist roller axis) is offset by approximately 2-3 mm downstream in a direction of recording sheet conveyance, compared to a center of rotation of the feeder roller 170 (feeder roller axis).

The feeder roller axis is positioned slightly lower than the resist roller axis, and the feeder roller 170 is closer than the primary resist rollers 150 to the feeder tray 21. Through the above configuration, only the outer circumferential surface of the feeder roller 170 is applied against an upper surface of the uppermost recording sheet S1 in the feeder tray 21, therefore ensuring a smooth pick-up movement of the uppermost recording sheet S1.

The internal gear 154a is formed from two gear wheels 156a provided one each at opposite ends of an axle 155a. More specifically, the gear wheels 156a are positioned slightly towards a center point of the axle 155a from respective ends of the axle 155a. The gear wheels 156a are fixed on the axle 155a, for example by forceful insertion of the axle 155a therethrough, or use of an adhesive.

The inner gear 154b has the same configuration as the inner gear 154a.

Compared to the inner gear 154a, the inner gear 154c has a configuration where an end of the axle 155a closest to the feeder roller 170 is extended, and a gear wheel 158 is additionally provided thereon.

The gear wheel 158 is identical to each of the gear wheels 156a, and as shown in FIG. 2, the gear wheel 158 is positioned so as to be on an opposite side of the supporting member 140 to the gear wheels 156a, sandwiching the supporting member 140 therebetween. The gear wheel 158 has a function of transmitting rotational movement of a central wheel 162 of a corresponding coupling unit 160 to the primary resist roller 150 (explained below in more detail).

Each of the secondary resist rollers 180, having a smaller diameter than the diameter D2 of each of the primary resist rollers 150, is pressed against a corresponding primary resist roller 150 forming a nip.

Positioning of each of the secondary resist rollers 180 in relation to the corresponding primary resist roller 150 is identical. The secondary resist roller 180 presses against the primary resist roller 150, and is driven by movement thereof.

As explained above, the diameter D1 of the feeder roller 170 and the diameter D2 of each of the primary resist rollers 150 are equal. Therefore, conveyance speed of the recording sheet S1 is identical for a pairing of the feeder roller 170 with the separation roller 190, and for pairings of each of the primary resist rollers 150 with the corresponding secondary resist roller 180.

Furthermore, a torque limiter (omitted in FIG. 2) is provided on an axle of each of the secondary resist rollers 180, and is configured so that when rotational drive is applied in one direction, a predetermined amount of torque arises in a direction resisting the rotational drive. The above configuration ensures that during skew correction, the primary resist rollers 150 do not rotate prematurely before skew correction is complete.

(Coupling Units 160)

Each of the coupling units 160 is configured as an intermediate for transmitting rotational drive of the feeder roller 170 to a corresponding primary resist roller 150 with a delay. Two coupling units 160 are provided one at each end of the feeder roller 170 along a Y-axis (rotational axis) thereof, thus each coupling unit 160 is positioned between the feeder roller 170 and the corresponding primary resist roller 150.

Each of the coupling units 160 is formed from an intermediate wheel 162 and a drive transmission shaft 165.

The intermediate wheel 162 is cylindrical with a base, and has an inner circumference gear 164 formed on an inner circumferential surface thereof. The inner circumference gear 164 has identical pitch and number of teeth to each of the inner circumference gears 153 of the corresponding primary resist roller 150. The inner circumference gear 164 meshes with the gear wheel 158 provided at the extended end of the gear axle 155a of a corresponding inner gear 154c.

The intermediate wheel 162 has a boss part 163 positioned centrally on a base surface thereof. The primary roller axle 171 inserts into the boss part 163, and thus the intermediate wheel 162 is supported by and freely rotatable around the primary roller axle 171.

When viewed in a Y-axis direction, a center point of the boss part 163 and a center of rotation of the inner circumference gear 164 are identical.

The inner circumference gear 164 of the coupling unit 160 is identical in terms of shape and number of teeth to each of the inner circumference gears 153 of the corresponding primary resist roller 150. Also, the inner circumference gear 164 meshes with the gear wheel 158 provided on the same axle as the corresponding inner gear 154c. Consequently, the intermediate wheels 162 each rotate at the same angular velocity as the corresponding primary resist roller 150.

The drive transmission shaft 165 may for example be a metal shaft. The drive transmission shaft 165 extends from a base part 161 of one of the intermediate wheels 162 in a direction perpendicular to the base part 161. The drive transmission shaft 165 extends through the long arc-shaped hole 174, provided in the core part 172 of the feeder roller 170, and extends to a base part 161 of the other intermediate wheel 162.

FIG. 2 shows the drive transmission shaft 165 in a state of contact with an inner wall 172b of the long arc-shaped hole 174 (initial engagement state). The drive transmission shaft 165 is configured so that when driving force from the primary roller axle 171 causes the feeder roller 170 to rotate in the anticlockwise direction, the drive transmission shaft 165 is disengaged from the initial engagement state and moved into a state of contact with an inner wall 172c of the long arc-shaped hole 174. Through the above configuration, once the drive transmission shaft 165 is in contact with the inner wall 172c, the intermediate wheels 162 rotate at an identical velocity to the feeder roller 170.

Rotation of each of the intermediate wheels 162 is transmitted to the corresponding primary resist roller 150 through the inner circumference gear 164, the inner gear 154c and the inner circumference gear 153. As a result, once the feeder roller 170 commences rotation, the primary resist rollers 150, after a delay corresponding to magnitude of a central angle of the long arc-shaped hole 174, each commence rotation at an identical velocity to the feeder roller 170.

In other words, the long arc-shaped hole 174 and the drive transmission shaft 165 act in cooperation to transmit rotational drive of the feeder roller 170 to the primary resist rollers 150 after a predetermined delay. Thus, the long arc-shaped hole 174 and the drive transmission shaft 165 function together as a delayed drive transmission unit.

Through the above configuration, after the recording sheet S1 is picked-up from the feeder tray 21, a loop is formed in the recording sheet S1 upstream of the nip between each of the primary resist rollers 150 and the corresponding secondary resist roller 180, thus allowing skew correction to be performed.

For the two primary resist rollers 150, positioned one each at opposite ends of the feeder roller 170, a distance therebetween (the shortest distance in the Y-axis direction between the outer skin 151 of each of the primary resist rollers 150) is set as smaller than the smallest expected width for the recording sheet S1. Through the above configuration, skew correction can be performed reliably even when recording sheets of a small size are used.

Once the recording sheet S1 has been conveyed out of the feeder mechanism 41, engagement between the drive transmission shaft 165 and the long arc-shaped hole 174 must be returned to the initial engagement state so that skew correction can be performed on a next recording sheet picked-up from the feeder tray 21. In the present embodiment, the reverse drive charging unit 200 is included in the feeder mechanism 41 in order to achieve the above.

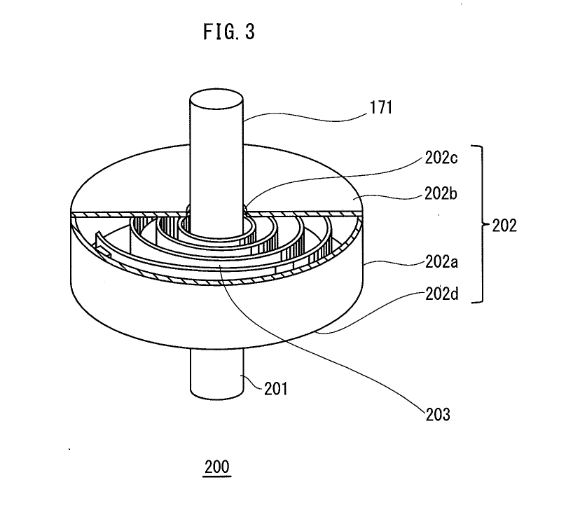

FIG. 3 shows configuration of the reverse drive charging unit 200.

As shown in FIG. 3, the reverse drive charging unit 200 is formed from a drive axle 201, a spiral spring 203 and a casing 202.

The drive axle 201 is connected to a driver (omitted in FIG. 3), and is rotationally driven thereby. An inner end of the spiral spring 203 is joined to the primary roller axle 171, and the other end (outer end) of the spiral spring 203 is joined to an inner surface of a body 202a of the casing 202.

The casing 202 is formed from the body 202a, a top plate 202b and a bottom plate 202d. The body 202a is a hollow cylinder, and the top plate 202b and the bottom plate 202d block openings at respective ends of the cylinder in an axial direction thereof. The spiral spring 203 is housed in the casing 202.

A hole 202c is provided in the top plate 202b so that one end of the primary roller axle 171 can be inserted into the casing 202. The drive axle 201 is connected centrally to the bottom plate 202d of the casing 202, so that the drive axle 201 is positioned on the same axis as the primary roller axle 171.

Through the above configuration, when driving of the feeder mechanism 41 commences, a portion of driving force from the driver is used for winding of the spiral spring 203 in the reverse drive charging unit 200, thus causing charging of elastic energy in the spiral spring 203. Once the recording sheet has been conveyed from the feeder mechanism 41, the driver is suspended, and the spiral spring 203 attempts to return to a pre-winding state causing clockwise rotation of the primary roller axle 171. The above causes a return to the initial engagement state of the long arc-shaped hole 174 and the drive transmission shaft 165.

(Feeder Mechanism 41 Operation)

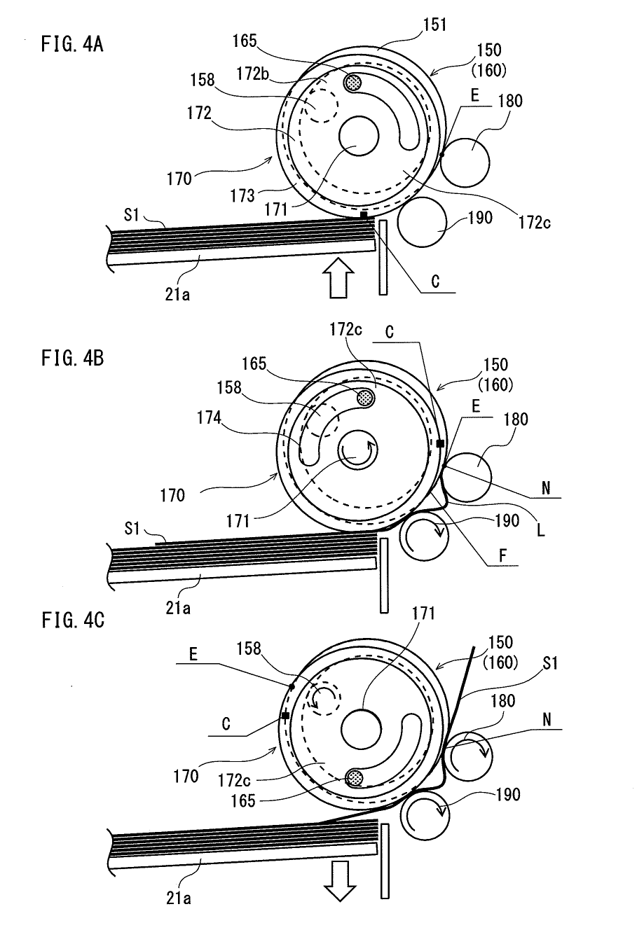

Feeding and loop formation operations in the feeder mechanism 41 are explained below with reference to FIGS. 4A-4C, which each show a side view of main elements of the feeder mechanism 41.

For ease of explanation of rotational movement, points C and E are marked on circumferential surfaces respectively of the feeder roller 170 and each of the primary resist rollers 150.

FIG. 4A shows the main elements of the feeder mechanism 41 when in the initial engagement state. In FIG. 4A, the drive transmission shaft 165 is in contact with the inner wall 172b of the long arc-shaped hole 174. Point C shows a lowest point on the circumferential surface of the feeder roller 170, and point E shows a contact position between the primary resist roller 150 and the corresponding secondary resist roller 180.

When a recording sheet is to be fed-in, in accordance with an instruction from the control unit 40, the sheet stacking surface 21a is raised by an actuator (omitted in FIGS. 4A-4C) so that the upper surface of the uppermost recording sheet S1 is in contact with the circumferential surface of the feeder roller 170, and the drive axle 201 (refer to FIG. 2) is rotationally driven in the anticlockwise direction by the driver (omitted in FIGS. 4A-4C).

Driving force is transmitted to the primary roller axle 171 through the spiral spring 203, and thus the primary roller axle 171 attempts to rotate the feeder roller 170. However, due to the recording sheet S1 and the torque limiter of the separation roller 190 that presses against the feeder roller 170, a certain amount of torque load is applied against the primary roller axle 171.

Due to the above, at least a portion of the driving force is used to power winding of the spiral spring 203, and therefore the portion of the driving force is converted to and stored as elastic energy.

Once there has been a certain amount of winding of the spiral spring 203, the driving force is transmitted to the main roller axle 171, and the feeder roller 170 rotates in the anticlockwise direction.

Through the above movement, the recording sheet S1 is conveyed in a rightwards direction of FIGS. 4A-4C, and passes through point F as shown in FIG. 4B. Point F is an intersection point of outer contour lines of the circumferential surfaces of the feeder roller 170 and the primary resist roller 150, when viewed as in FIG. 4B.

A portion of the recording sheet S1 that has passed through point F slides across the circumferential surface of the primary resist roller 150, which is temporarily stationary, as it is conveyed. Eventually, the recording sheet S1 contacts with a nip N formed between the primary resist roller 150 and the corresponding secondary resist roller 180 at point E. Due to the torque limiter (omitted in FIGS. 4A-4C) provided on the rotational axle of the corresponding secondary resist roller 180, a leading part of the recording sheet S1 pushing against the nip N is insufficient to cause rotation of the primary resist roller 150 and the corresponding secondary resist roller 180.

Once the above situation has been reached, the recording sheet S1 continues to be conveyed by the feeder roller 170, causing formation of a loop L in the recording sheet S1 as shown in FIG. 4B.

When the loop L forms, stiffness of the recording sheet S1 causes an edge of the leading part of the recording sheet S1 to align with the nip N (parallel to the axial direction of the primary resist roller 150).

Rotation of the feeder roller 170 moves the drive transmission shaft 165 into contact with the inner wall 172c of the long arc-shaped hole 174, thus causing the primary resist roller 150 to commence rotation in the anticlockwise direction at an identical velocity to the feeder roller 170. Through the above configuration, the recording sheet S1 is conveyed further downstream in a skew corrected state (refer to FIG. 4C).

A conveyance speed of the recording sheet S1 when passing between the feeder roller 170 and the separation roller 190, is set as equal to a conveyance speed of the recording sheet S1 when passing between the primary resist roller 150 and the corresponding secondary resist roller 180. The above ensures that there is no excessive tension applied to or slackness of the recording sheet S1 during conveyance.

In order to ensure that the next recording sheet is not fed-in while the loop is being formed in the recording sheet S1 and while a trailing part of the recording sheet S1 has not yet been conveyed through the feeder mechanism 41, the control unit 40 lowers the sheet stacking surface 21a of the feeder tray 21 using the driver.

In order to achieve the above, lowering of the sheet stacking surface 21a should preferably be performed while the trailing part of the recording sheet S1 is still positioned between the circumferential surface of the feeder roller 170 and the next recording sheet S. To ensure correct timing, the lowering may for example be performed a predetermined amount of time after the drive axle 201 commences rotation, or alternatively a reflective photosensor may be provided at a point downstream of the nip N in the conveyance direction of the recording sheet S1, and the lowering may be performed when the reflective photosensor detects the leading part of the recording sheet S1.

The control unit 40 stops rotational drive of the primary roller axle 171 at a point in time when the trailing part of the recording sheet S1 has passed through the nip N, or at a time thereafter.

For example, if the reflective photosensor is provided at the point downstream of the nip N, rotational drive of the primary roller axle 171 may be stopped when the reflective photosensor detects the trailing part of the recording sheet S1. Alternatively, if no reflective photosensor is provided, rotational drive of the primary roller axle 171 may be stopped a predetermined amount of time after the drive axle 201 commences rotation.

When rotational drive of the primary roller axle 171 is stopped, the elastic energy charged in the reverse drive charging unit 200 is released, causing reverse rotation of the primary roller axle 171 in a clockwise direction shown in FIG. 4C.

When the primary roller axle 171 commences reverse rotation, only the feeder roller 170 and the separation roller 190 are rotated, therefore the reverse drive charging unit 200 is able to overcome torque produced by the torque limiter of the separation roller 190, causing reverse rotation of the feeder roller 170. The above causes the drive transmission shaft 165 to move into contact with the inner wall 172b of the long arc-shaped hole 174.

If the reverse drive charging unit 200 is to cause further reverse rotation of the feeder roller 170, beyond the point described above, the coupling units 160, the primary resist rollers 150 and the secondary resist rollers 180 must also be reverse rotated. In particular, torque is produced by the torque limiter of each of the secondary resist rollers 180. If enough energy remains charged in the reverse drive charging unit 200 to overcome the above torque, there is further reverse rotation due to the remaining energy.

The above causes relative positions of the feeder roller 170 and the primary resist rollers 150 to return to the initial engagement state shown in FIG. 4A. Thus, feeding of the next recording sheet is now possible.

Through the above configuration the feeder roller 170 and each of the primary resist rollers 150 can be caused to return to a standard position. Consequently, there is no need to control the driver in order to cause reverse rotation of the primary roller axle 171.

In the first embodiment, through delayed transmission of rotational drive of the feeder roller 170 to the primary resist rollers 150, a single driver can be used for both the feeder roller 170 and the primary resist rollers 150. The above is achieved in the first embodiment while also allowing reliable loop formation, skew correction and conveyance of the recording sheet.

When viewed in the direction of the rotational axis, the outer circumference 173 of the feeder roller 170 overlaps almost completely with the outer skin 151 of each of the primary resist rollers 150. Therefore, separation between the feeder roller 170 and the primary resist rollers 150 can be small, allowing the image forming apparatus to be compact in size.

### Second Embodiment

Configuration of a feeder mechanism relating to a second embodiment is largely the same as configuration of the feeder mechanism 41 relating to the first embodiment. However, configuration of the feeder mechanism relating to the primary resist rollers 150, and the intermediate wheel 162 of each of the coupling units 160, differs from configuration of the feeder mechanism 41 relating to the first embodiment.

Configuration elements that are the same as in the first embodiment are referred to below using the same reference symbols, and description thereof is omitted or abbreviated in order to focus on configuration elements that are different.

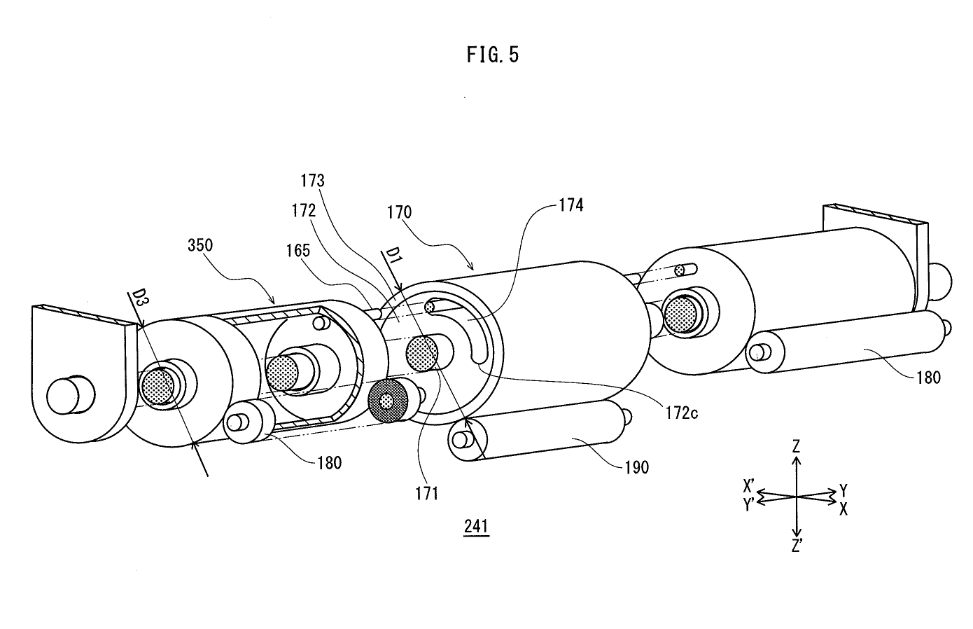

FIG. 5 is a partially cutaway perspective diagram showing configuration of main elements of the feeder mechanism relating to the second embodiment.

As shown by FIG. 5, in the feeder mechanism 241 relating to the second embodiment there is no configuration corresponding to the coupling units 160. Furthermore, two primary resist rollers 350, corresponding to the two primary resist rollers 150 in the first embodiment, are supported by and freely rotatable around the primary roller axle 171 of the feeder roller 170. In other words, the feeder roller 170 and each of the primary resist rollers 350 are positioned on the same axis. In contrast, each of the primary resist rollers 150 in the first embodiment is supported by the three internal gears 154a-154c.

In contrast to the feeder roller 170, which is fixed on the primary roller axle 171, each of the primary resist rollers 350 is supported by the primary roller axle 171 without fixation thereon.

Consequently, driving force from the driver connected to the primary roller axle 171 is only directly transmitted to the feeder roller 170.

One end of the drive transmission shaft 165 is joined to an end surface of one of the primary resist rollers 350, and the other end of the drive transmission shaft 165 is joined to an end surface of the other of the primary resist roller 350.

In the above configuration where the feeder roller 170 and the primary resist rollers 350 are positioned on the same axis, preferably a diameter D3 of each of the primary resist rollers 350 should be set marginally smaller than the diameter D1 of the feeder roller 170.

Reasoning behind the above is that particularly in a configuration where the feeder roller 170 also functions as a pick-up roller, if the primary resist rollers 350 are equal in diameter to the feeder roller 170, the primary resist rollers 350 may also contact with the uppermost recording sheet S1 (refer to FIG. 1) stacked in the feeder tray 21. In the above situation, when the feeder roller 170 attempts to pick-up the recording sheet S1, rotation of the primary resist rollers 350 may be caused by friction with the recording sheet S1. The above rotation of the primary resist rollers 350 means that the recording sheet S1 might be conveyed in a non-skew corrected state.

Preferably, a difference between the diameter D1 of the feeder roller 170 and the diameter D3 of each of the primary resist rollers 350 should be small.

Reasoning behind the above is that the larger the diameter D1 is compared to the diameter D3, the larger conveyance speed of the recording sheet S1 by the feeder roller 170 is compared to conveyance speed of the recording sheet S1 by the primary resist rollers 350. If the conveyance speed by the feeder roller 170 is significantly larger, once the leading part of the recording sheet S1 has passed through the nip formed between each of the primary resist rollers 350 and the corresponding secondary resist roller 180, the loop formed in the recording sheet S1 in order to perform skew correction may become increasingly large. If the loop becomes too large, the loop may become caught in the nip between each of the primary resist rollers 350 and the corresponding secondary resist roller 180, thus preventing correct sheet feeding.

In the second embodiment, through setting the diameter D3 of each of primary resist rollers 350 as marginally smaller than the diameter D1 of the feeder roller 170, the feeder roller 170 is able to rotate while in contact with an inner surface the recording sheet S1, even when the primary resist rollers 350 are stationary.

In contrast to the feeder roller 170, each of the primary resist rollers 350 is pressed against by the corresponding secondary resist roller 180, which is coupled to the torque limiter (omitted in FIG. 5). Through setting a torque value of the torque limiter sufficiently high, friction from the recording sheet S1 and the feeder roller 170 can be counteracted. In other words, rotation of the primary resist rollers 350 due to transmission of driving force through the recording sheet S1 is prevented.

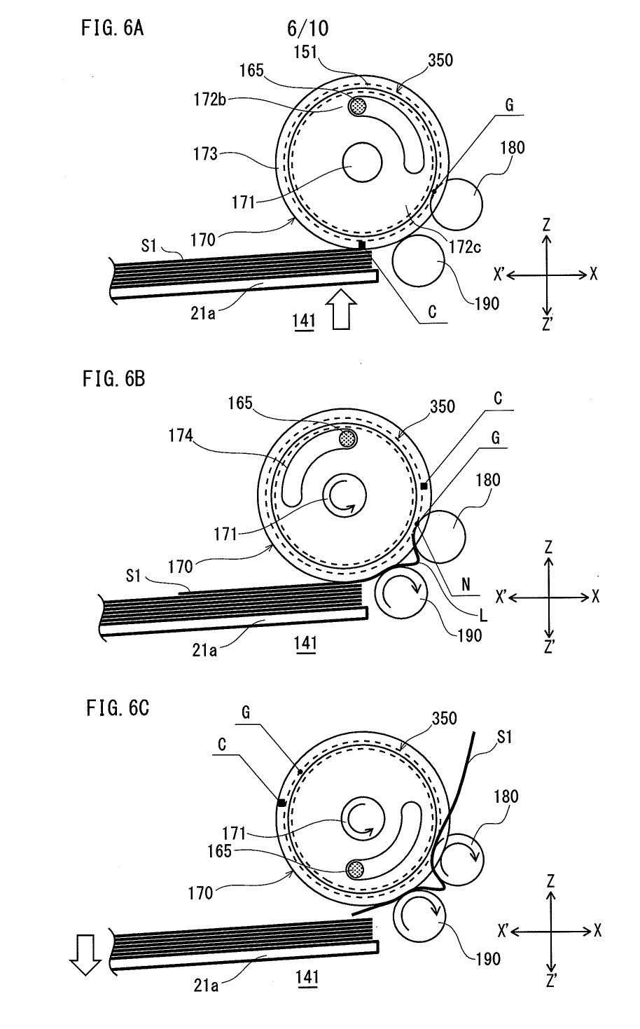

FIGS. 6A-6C show operation of the feeder mechanism 241 relating to the present embodiment.

For ease of explanation of rotational movement of the feeder roller 170 and each of the primary resist rollers 350, points C and G are marked on respective circumferential surfaces thereof.

As shown in FIG. 6A, the feeder roller 170 and the primary resist roller 350 are positioned on the same axis. Furthermore, the feeder roller 170 is larger in diameter than the primary resist roller 350, therefore when viewed in the direction of the rotational axis as in FIG. 6A, a contour line of an outer skin of the primary resist roller 350 is contained completely within a contour line of an outer skin of the feeder roller 170.

Before the main roller axle 171 commences rotation the drive transmission shaft 165 is in contact with the inner wall 172b of the core part 172.

In the above situation, point C shows a lowest point on the feeder roller 170 and point G shows a point of contact the primary resist roller 350 and the corresponding secondary resist roller 180.

When a recording sheet is to be fed-in, in accordance with an instruction from the control unit 40, the sheet stacking surface 21a is raised by the actuator so that the upper surface of the uppermost recording sheet S1 is in contact with the circumferential surface of the feeder roller 170, and the primary roller axle 171 is rotationally driven in the anticlockwise direction by the driver (omitted in FIGS. 6A-6C).

Through the above, the recording sheet S1 is picked-up and conveyed in a direction corresponding to rightwards movement in FIG. 6B.

When the feeder roller 170 rotates, the core part 172 thereof also rotates in the anticlockwise direction. The long arc-shaped hole 174 extends in the direction of rotation, therefore driving force is not transmitted to the drive transmission shaft 165 inserted therethrough until the drive transmission shaft 165 is brought into contact with the inner wall 172c of the core part 172.

Consequently, each of the primary resist rollers 350 connected to the drive transmission shaft 165 remain stationary until the drive transmission shaft is in contact with the inner wall 172c. In other words, there is no change in position of point G

As shown in FIG. 6B, by the time the drive transmission shaft 165 is in contact with the inner wall 172c, point C on the feeder roller 170 has moved to a new position slightly beyond point G

Through the above, the leading part of the recording sheet S1 is conveyed towards a point approximately equivalent to point C, however partway through the above movement the leading part of the recording sheet S1 is pressed against the nip N formed between the primary resist roller 350 and the corresponding secondary resist roller 180.

Even once the leading part of the recording sheet S1 is pressed against the nip N, the trailing part of the recording sheet S1 continues to be conveyed, and therefore the loop L is formed in the recording sheet S1 as shown in FIG. 6B.

The diameter D1 of the feeder roller 170 is marginally larger than the diameter D3 of each of the primary resist rollers 350, therefore when the loop L is formed in the recording sheet S1, at point G two opposite side edge sections of the recording sheet S1, in terms of a width direction thereof, are respectively in contact with the two primary resist rollers 350. A central section of the recording sheet S1, in terms of the width direction thereof, is in contact with the feeder roller 170. Through the above, the edge of the leading part of the recording sheet S1 becomes approximately parallel to the axial direction of the primary resist rollers 350.

In the above situation, once the drive transmission shaft 165 is brought into contact with the inner wall 172c, rotational driving force is applied against the drive transmission shaft 165 in the anticlockwise direction as shown in FIG. 6C, thus also causing rotation of the primary resist rollers 350.

Rotation of the primary resist rollers 350 causes conveyance of the leading part of the recording sheet S1, and thus the recording sheet S1 is conveyed downstream in the skew corrected state as in the first embodiment.

During the above operations, the control unit 40 lowers the sheet stacking surface 21a of the feeder tray 21 using the driver (omitted in FIGS. 6A-6C), in order to ensure that the feeder roller 170 is not in contact with recording sheets on the sheet stacking surface 21a. The above prevents the next recording sheet being fed-in prematurely.

In the above configuration, when viewed in the direction of the rotational axis the feeder roller 170 and the primary resist rollers 150 each have a center of rotation at the same position. In other words, the outer skin of the feeder roller 170 overlaps the entire circumference of the outer skin of each of the primary resist rollers 350. Consequently, the image forming apparatus including the feeder mechanism 241 can be more compact in terms of size.

In the second embodiment there is delayed transmission of the rotational drive causing rotation of the feeder roller 170 to the primary resist rollers 350. Thus, a single driver can be used for both the feeder roller 170 and the primary rollers 350, while also ensuring reliable loop formation, skew correction and conveyance of the recording sheet. The above configuration allows a reduction in cost of the image formation apparatus including the feeder mechanism 241.

### Third Embodiment

Configuration of a feeder mechanism relating to a third embodiment is generally the same as configuration of the feeder mechanism 41 relating to the first embodiment. However, configuration of the primary resist rollers 150 differs from in the feeder mechanism 41.

Configuration elements that are the same as in the first embodiment are referred to below using the same reference symbols, and description thereof is omitted or abbreviated in order to focus on configuration elements that are different.

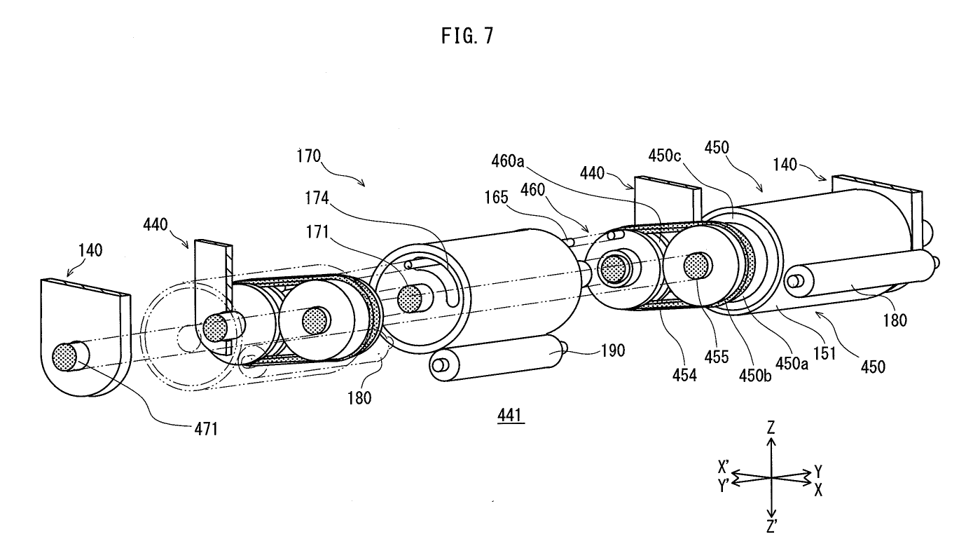

FIG. 7 is a perspective diagram showing configuration of main elements of a feeder mechanism 441 relating to the third embodiment.

As shown in FIG. 7, the feeder mechanism 441 relating to the third embodiment includes two coupling units 460a that have a different configuration to the two coupling units 160 in the first embodiment. Furthermore, the feeder mechanism 441 includes two primary resist rollers 450, which correspond to the two primary resist rollers 150 in the first embodiment. The primary resist rollers 450 are not each supported by three internal gears as in the first embodiment, but are instead supported by a secondary roller axle 455 that is adjacent and extending in parallel to the primary roller axle 171, which supports the feeder roller 170. In the first embodiment coupling between each of the coupling units 160 and the corresponding primary resist roller 150 is through gears, but in the third embodiment, each of the coupling units 460a is coupled to a corresponding primary resist roller 450 through a belt 454.

In the same way as for the coupling units 160 in the first embodiment, the two coupling units 460a are positioned one each at two ends of the feeder roller 170 in terms of the Y-axis direction. The drive transmission shaft 165 extends from one of the coupling units 460a to the other of the coupling units 460a.

Two supporting members 440, which are narrower in terms of an X-axis direction than the supporting members 140 in the first embodiment, support the primary roller axle 171. The supporting members 440 are narrower in order to avoid interference with the primary resist rollers 450.

As described above, the primary resist rollers 450 are supported by the secondary roller axle 455 which is adjacent and parallel to the primary roller axle 171 supporting the feeder roller 170. Each of the primary resist rollers 450 is formed from the outer skin 151, a core part 450c corresponding to the core part 172 in the first embodiment, and a pulley part 450a, which is provided on one end of the core part 450c in terms of the Y-axis direction.

The pulley part 450a is a solid cylinder, having a groove 454b in an outer circumference thereof against which the belt 454 of the corresponding coupling unit 460a winds.

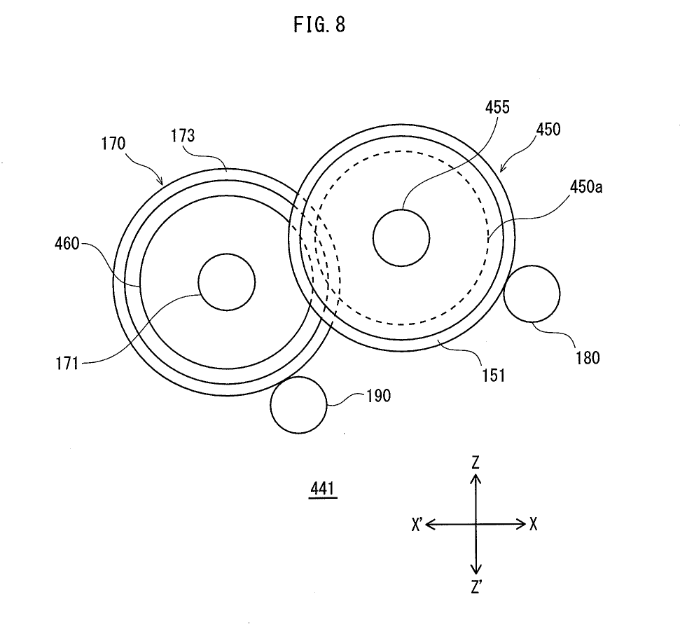

FIG. 8 shows the feeder mechanism 441 viewed in the direction of the rotational axis of the feeder roller 170 (viewed from a side Y′ shown in FIG. 7).

The belt 454 is omitted in FIG. 8.

The feeder roller 170 and each of the primary resist rollers 450 are positioned so that when viewed in the direction of the rotational axis, a portion of the outer circumference 173 of the feeder roller 170 overlaps with a portion of the outer skin 151 of the primary resist roller 450. Therefore, the image forming apparatus including the feeder mechanism 441 can be made more compact in size.

Furthermore, the drive transmission shaft 165 and the long arc-shaped hole 174 function as a delayed drive transmission unit in the same way as in the first embodiment. Therefore, a single driver can be used to cause the feeder roller 170 and the primary resist rollers 450 to commence rotation at different times, thus skew correction can be performed and costs can be reduced through use of just the single driver.

### Modified Examples

The present invention is not limited to the embodiments given above, and alternatively may be realized as described in modified examples given below.

(1) In the first embodiment the separation roller 190 presses against the feeder roller 170, but alternatively the separation roller 190 may be replaced by any pressing member that presses against the feeder roller 170. For example the pressing member may be a fixed pressing pad that does not rotate.

(2) In the first embodiment the feeder roller 170 also functions as a pick-up roller. Alternatively, a pick-up roller may be provided in addition to the feeder roller 170.

(3) In the first embodiment, the diameter D1 of the feeder roller 170 is equal to the diameter D2 of each of the primary resist rollers 150. Alternatively, the diameter D1 may be different to the diameter D2, so long as the difference does not cause creasing of or excessive tension on the recording sheet.

For example, the diameter D1 may differ from the diameter D2 so long as the diameter D2 is not so large that the primary resist rollers 150 are in contact with the uppermost recording sheet S1 when the sheet stacking surface 21a of the sheet feeder 21 is raised as in FIG. 4A.

If the diameter D1 is different to the diameter D2, preferably the inner gears 154c should each have a different gear ratio at a side of the corresponding coupling unit 160 compared to a side of the corresponding primary resist roller 150. The above is in order to ensure that a circumferential surface (outer circumference of the circumferential part 173) of the feeder roller 170 and a circumferential surface (outer circumference of the outer skin 151) of each of the primary resist rollers 150 are equal in terms of rotational velocity.

(4) In the first embodiment the long arc-shaped hole 174 is provided on the feeder roller 170, and the drive transmission shaft 165 is attached to the coupling units 160. However, the above is not a limitation on the present invention.

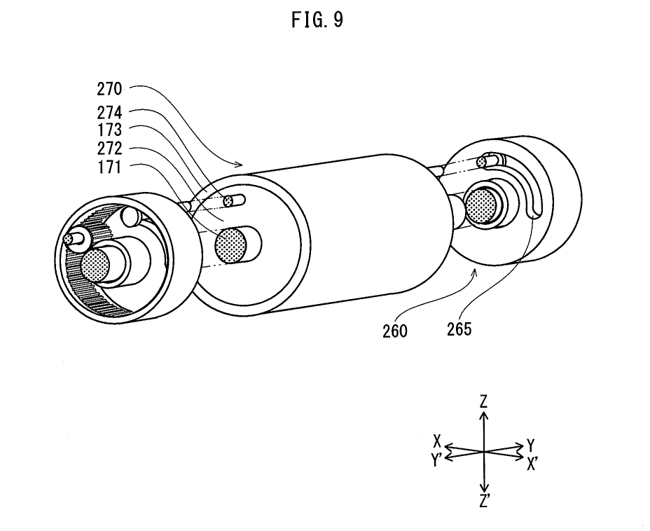

For example, as shown in FIG. 9, alternatively a long arc-shaped hole 265, corresponding to the long arc-shaped hole 174 in the first embodiment, may be provided on each of two coupling units 260, corresponding to the coupling units 160 in the first embodiment. Furthermore, a drive transmission shaft 274, corresponding to the drive transmission shaft 165 in the first embodiment, may be provided extending in the Y-axis direction from both ends of a core part 272 of a feeder roller 270, corresponding to feeder roller 170 in the first embodiment.

(5) In the first embodiment, the delayed drive transmission unit is configured as the long arc-shaped hole 174 and the drive transmission shaft 165. However, the above is not a limitation on the present invention.

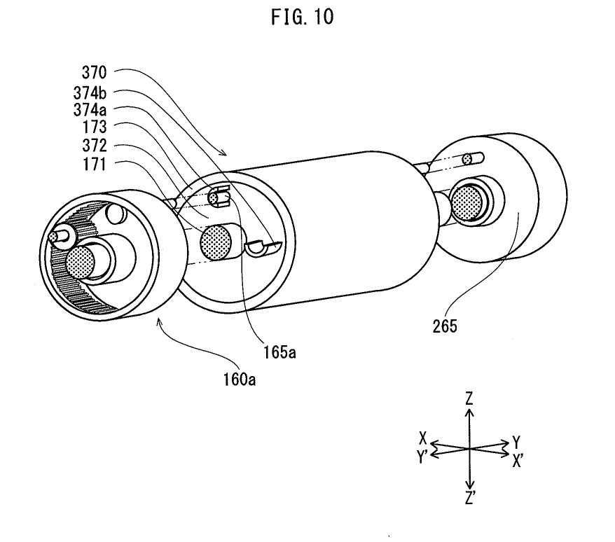

For example, the delayed drive transmission unit may alternatively be configured as shown in FIG. 10. A first engaging part 374a and a second engaging part 374b are provided at each end, in terms of the Y-axis direction, of a core part 372 of a feeder roller 370, corresponding to the feeder roller 170 in the first embodiment. The first engaging part 374a and the second engaging part 374b are positioned so that when viewed in the direction of the rotational axis (Y-axis direction), the first engaging part 374a and the second engaging part 374b are separated from one another by a predetermined angle measured from the primary roller axle 171 of the feeder roller 370. A protrusion 165a is provided on an end, in terms of the Y-axis direction, of each of two coupling units 160a, which correspond to the coupling units 160 in the first embodiment. Each of the protrusions 165a engages selectively with the first engaging unit 374a and the second engaging unit 374b at a corresponding end of the feeder roller 370, depending on a state of rotation of the feeder roller 370.

(6) The image forming apparatus in the first embodiment is a monochrome image forming apparatus. However, the above is not a limitation on the present invention. Alternatively, the image forming apparatus may be four-cycle type image forming apparatus, or a tandem type color printer for forming a full-color image. Configuration of the present invention is not limited to printers, and may also be applicable for photocopiers, fax machines, MFPs and the like.

The feeder mechanism 41 may also be applicable for skew correction in an ADF (Auto Document Feeder).

In the above type of apparatus, usually original documents stacked in a feeder tray are picked-up in a downwards direction, therefore the feeder roller 170 should preferably be positioned so as to be in contact with a lower surface of a lowermost original document.

The present invention may also be configured as any appropriate combination of the embodiments and the modified examples described above.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image forming apparatus for forming an image, including a sheet feeding device that corrects skew of a sheet before feeding the sheet to a transfer position of a toner image for image formation, the sheet feeding device comprising:
a driver;
a feeder roller unit provided with a feeder roller that is rotationally driven by the driver, and a pressing member that presses against a circumferential surface of the feeder roller forming a first nip; and
at least two resist roller units that cause formation of a loop in the sheet between the resist roller units and the feeder roller unit during skew correction, each resist roller unit provided with a first resist roller and a second resist roller that press against one another forming a second nip, wherein
the first resist roller and the feeder roller are positioned so that (i) when viewed in a direction of a rotational axis of the feeder roller, the first resist roller and the feeder roller overlap at least partially, and (ii) the first resist roller and the feeder roller occupy different positions with respect to the direction of the rotational axis, and
the pressing member and the second resist roller are positioned so that when viewed in the direction of the rotational axis, the pressing member and the second resist roller do not overlap.

2. The image forming apparatus in claim 1, wherein
the sheet feeding device further comprises
a plurality of delayed drive transmission units, each delaying transmission of rotational drive of the feeder roller to one of the first resist rollers, thereby causing the first resist roller to commence rotation a predetermined time period after the feeder roller commences rotation, the delayed drive transmission unit provided with:
a first engaging part and a second engaging part that are positioned at an end, in terms of the direction of the rotational axis, of one of the feeder roller and the first resist roller; and
an engagement receiving part positioned at an end of the other of the feeder roller and the first resist roller, wherein
the first engaging part and the second engaging part, when viewed in the direction of the rotational axis, are separated from one another by a predetermined angle measured from a rotational axis of the one of the feeder roller and the first resist roller,
the engagement receiving part engages selectively with the first engaging part and the second engaging part based on rotation of the feeder roller relative to the first resist roller, and
rotation of the feeder roller causes rotational movement of the engagement receiving part relative to the first and second engaging parts, thereby causing disengagement from a first engagement state, where the engagement receiving part is engaged with the first engaging part, and switching to a second engagement state, where the engagement receiving part is engaged with the second engaging part, and once switched to the second engagement state, the first resist roller commences rotation coupled to the rotation of the feeder roller.

3. The image forming apparatus in claim 2, wherein
a long arc-shaped hole that runs approximately parallel to a circumferential direction of the feeder roller is provided in the one of the feeder roller and the first resist roller,
the first engaging part is an inner wall at one end, in an arc direction, of the long arc-shaped hole,
the second engaging part is an inner wall at an opposite end, in the arc direction, of the long arc-shaped hole, and
the engagement receiving part is a shaft that extends, in the direction of the rotational axis, into the long arc-shaped hole.

4. The image forming apparatus in claim 2, wherein
compared to a center of rotation of the feeder roller, a center of rotation of the first resist roller is offset by a predetermined distance downstream in a direction of sheet conveyance, and
the delayed drive transmission unit is further provided with:
an intermediate rotator positioned on the same axis as the feeder roller; and
an intermediate transmission part that transmits rotation of the intermediate rotator to the first resist roller.

5. The image forming apparatus in claim 2, wherein
the feeder roller and the first resist roller are positioned on the same axis.

6. The image forming apparatus in claim 2, wherein
the feeder roller unit is further provided with a reverse drive charging part positioned in a drive transmission path between the driver and the feeder roller, the reverse drive charging part charging driving force in an opposite direction to rotation of the feeder roller, caused by the driver, when drive transmission commences, and
release of the driving force charged in the reverse drive charging part causes the engagement receiving part to return from the second engagement state to the first engagement state.

7. The image forming apparatus in claim 6, wherein
the reverse drive charging part is a spiral spring.

8. The image forming apparatus in claim 1, wherein
the feeder roller is in contact with one of an uppermost sheet and a lowermost sheet among a plurality of stacked sheets, and the feeder roller functions as a pick-up roller by picking-up the one of the uppermost sheet and the lowermost sheet.

9. The image forming apparatus in claim 1, wherein
the pressing member is a separation roller.

10. The image forming apparatus in claim 4, wherein
a maximum external diameter of the feeder roller and a maximum external diameter of the first resist roller are equal.

11. The image forming apparatus in claim 5 wherein,
the sheet feeding device further comprises
a feeder tray having the sheet stacked therein, wherein
a maximum external diameter of the feeder roller is greater than a maximum external diameter of the first resist roller, and
the feeder roller is in contact with the sheet on the feeder tray, and picks-up the sheet therefrom.

12. The image forming apparatus in claim 2, wherein
the first engaging part, the second engaging part and the engagement receiving part are each a protrusion.

13. The image forming apparatus in claim 1, wherein
two first resist rollers, provided in the at least two resist roller units, are positioned one each at each end of the feeder roller in terms of the direction of the rotational axis, and are separated from one another by a distance which is set smaller than a smallest expected width of the sheet.

14. A sheet feeding device for feeding a sheet and correcting skew thereof, the sheet feeding device comprising:
a driver;
a feeder roller unit provided with a feeder roller that is rotationally driven by the driver, and a pressing member that presses against a circumferential surface of the feeder roller forming a first nip; and
at least two resist roller units that cause formation of a loop in the sheet between the resist roller units and the feeder roller unit during skew correction, each resist roller unit provided with a first resist roller and a second resist roller that press against one another forming a second nip, wherein
the first resist roller and the feeder roller are positioned so that (i) when viewed in a direction of a rotational axis of the feeder roller, the first resist roller and the feeder roller overlap at least partially, and (ii) the first resist roller and the feeder roller occupy different positions with respect to the direction of the rotational axis, and
the pressing member and the second resist roller are positioned so that when viewed in the direction of the rotational axis, the pressing member and the second resist roller do not overlap.
